(19) United States
(12) Patent Application Publication
(10) Pub. No.: US 2010/0323321 A1
(43) Pub. Date: Dec. 23, 2010

(54) PORTABLE TEETH-CLEANSING AND PURGING DEVICE

(76) Inventor: Seijin Liao, Nanhua Hsiang (TW)

Correspondence Address: LEONG C. LEI, PMB # 1008, 1839 YGNACIO VALLEY ROAD, WALNUT CREEK, CA, 94598, US

(21) Appl. No.: 12/485,944

(22) Filed: Jun. 17, 2009

(51) Int. Cl. A61C 17/00

(52) U.S. Cl. 433/89

(57) ABSTRACT

A portable teeth-cleansing and purging device is disclosed. The device comprises a manual-operated pump, and a ejecting tube module. The manual-operated pump is a reciprocating pump which possesses a body and a pressing rod. The body is in communication externally with a suction tube having a water outlet. The ejecting tube module is a resilient tube having the ends mounted with a connector head and a purging head. The connector head is connected to the outer surrounding of the water outlet, and the purging head is a hollow tubing element. The end of the water outlet is a nozzle. By pressing and releasing of the pressing rod, the manual-operated pump is triggered to deliver a fixed amount of water supply via the water outlet, and as a result of restriction by the nozzle, a pressurized water stream for cleansing the gaps between the teeth is obtained. The device mitigates the requirement of current supply and water source in cleansing teeth. The device is portable and simple in structure.

### TECHNICAL FIELD OF THE INVENTION

The present invention relates to device for cleansing teeth, and in particular, a teeth-cleansing and purging device, which cleans teeth without the restriction of current supply or water supply restriction.

### DESCRIPTION OF THE PRIOR ART

Brushing teeth is a basic procedure to clean teeth after eating. However, it is very common that food resides are trapped in between teeth, which are not cleaned by brushing. Normally, flows or teeth-cleansing device is used for further treating and preferably, a teeth-cleansing and purging device is used.

Conventional teeth-cleansing and purging device employs water as a medium to generate an appropriate water stream to remove food resides trapped in between the teeth. The conventional teeth-cleansing or purging device is made from complicated component, and it needs current supply in order to operate the device. It is therefore not convenient.

Another type of teeth-cleansing or purging device is a device that mounted to a water tap to produce a pressurized water stream. However, when water pressure from a water source is low the device cannot be mounted to the tap and accordingly, it is not convenient to be carried along.

As a results of the above drawbacks mentioned, the invention has invented a teeth-cleansing and purging device which mitigates the above drawbacks.

### SUMMARY OF THE INVENTION

Accordingly, it is an object of the present invention to provide a portable teeth-cleansing and purging device comprising a manual-operated pump which is a reciprocating pump having a body and a pressing rod in communication externally with a suction tube having a water outlet, wherein the pressing and releasing of the pressing rod trigger the manual-operated pump to deliver a fixed amount of water supply via the water outlet, the suction tube is mounted with a filter, the lower section of the body is a rotating cap with threads, and the bottom face between the rotating cap and the suction tube is a protruded clipping rib, and a gap is formed between the clipping rib and the center tube, and the top section of the body is a cavity; and an ejecting tube module which is a resilient tube having the ends mounted with a connector head and a purging head, and the connector head being connected to the outer surrounding of the water outlet, and the purging head a hollow tubing element, and the end of the water outlet is a nozzle which is bent at and angle of 45 degree, and the diameter of the nozzle is smaller than that of the resilient tube, and the purging head has a handle.

Other objects, and advantages will become more apparent in view of the following detailed description in conjunction with the accompanying drawings.

### BRIEF DESCRIPTION OF THE DRAWINGS

FIG. 1 is a schematic exploded view of a preferred embodiment of the present invention.

FIG. 2 schematically shows the manual-operated pump of the present invention.

FIG. 3 illustrates the manual-operated pump connected to a PET bottle in accordance with the present invention.

FIG. 4 is a schematic view showing the manual-operated pump placed beside container in accordance with the present invention.

### DETAILED DESCRIPTION OF THE PREFERRED EMBODIMENTS

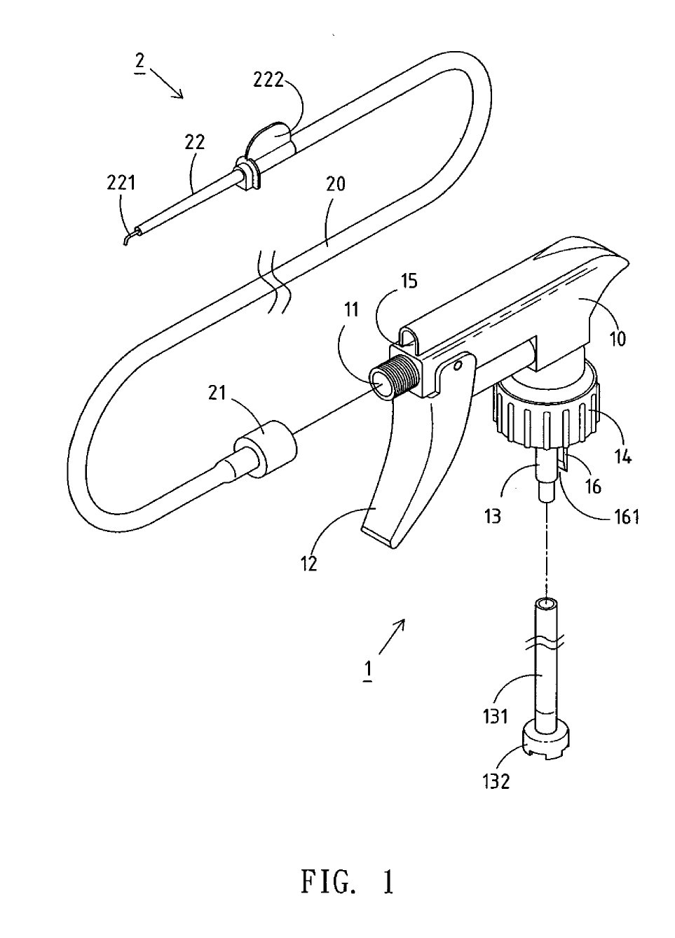

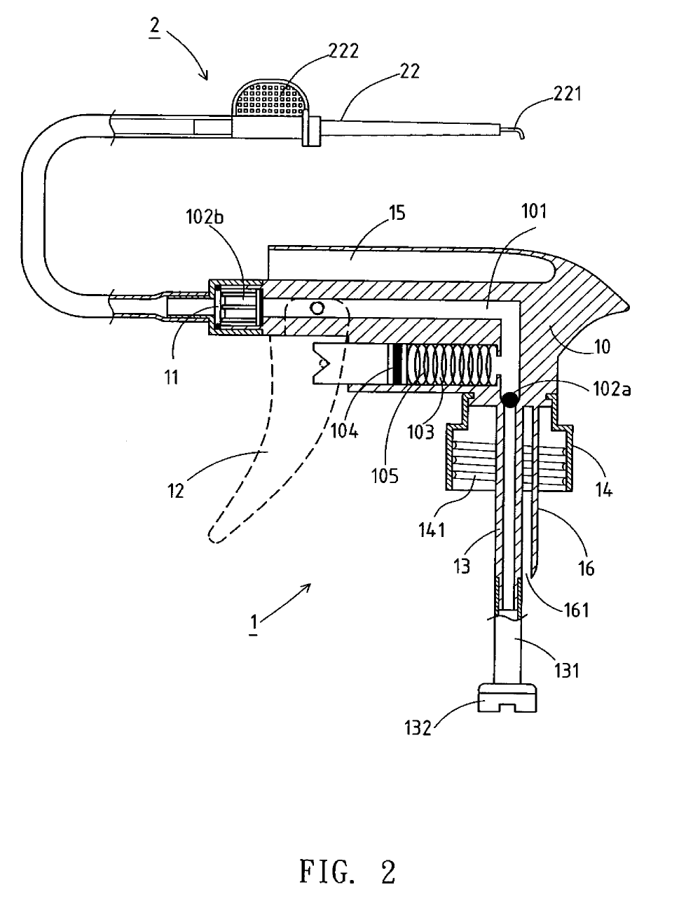

Referring to FIGS. 1 and 2, there is shown a portable teeth-cleansing and purging device of the present invention comprising a manual-operated pump 1 and an ejection tube mode 2. The pump 1 is a reciprocating pump, and the body 10 of the pump has a pressure cavity 101 mounted with two uni-direction valve 102a, 102b. The uni-direction valve 102a has an inwardly opening which is in communication to a suction tube 131. The uni-direction valve 102b has an outwardly opening which is in communication with a water outlet 11. The change of pressure in the pressure cavity will cause one valve to close and the other to open so as to upward deliver the liquid. A piston cavity 103 is in communication with the pressure cavity 101 and a piston 104 and a restoration spring 105 are provided within the piston cavity 103. A pressing rod 12 urges the piston 104, hand is used to press or release the pressing rod 12 such that the piston forms a reciprocating movement which causes the pressure in the pressure cavity 101 to change between positive and negative. Thus, when the suction tube 131 is within the cavity containing a cleansing liquid, the water and the lower section is transformed upward and a water with fixed amount is delivered through the water outlet 11.

The ejecting tube module 2 is a resilient tube 20 having two ends mounted with a connector head 21 and a purging head 22. The inner edge of the connector head 21 is threaded which could be connected to the external edge of the water outlet 11 of the manual-operated pump. The purging head 22 is a hollow tube having an outlet end mounted with a nozzle 221 bent at an angle of 45°. The tube diameter of the nozzle 221 is the size which is tapered to increase water pressure. The purging head 22 has a handle 222 which facilitates the holding to deeply cleanse the internal of the mouth cavity and the gaps between the teeth. The nozzle 221 is directly pointed to the area to be cleansed such that the efficiency of cleansing is high.

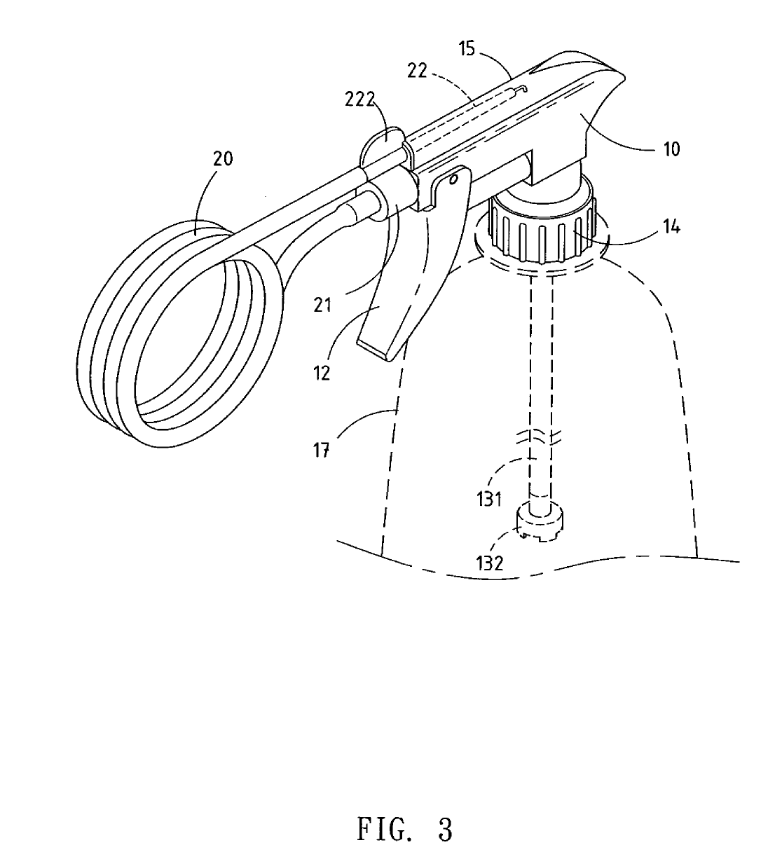

As shown in FIGS. 2 and 3, the lower section of the body 10 is a rotating cap 14 with threads 141. The threads 141 are similar to those caps used in bottles. Thus, the manual-operated pump could be simply mounted to the container containing water. The top section of the body is further provided with a cavity 15 which is used to hold the purging head 22, and it is used to prevent dust from contaminating the purging head 22. The lower end of a suction tube 131 is provided with a heavy weight filter 132, which is function for filtering and used to prevent the nozzle from being blocked.

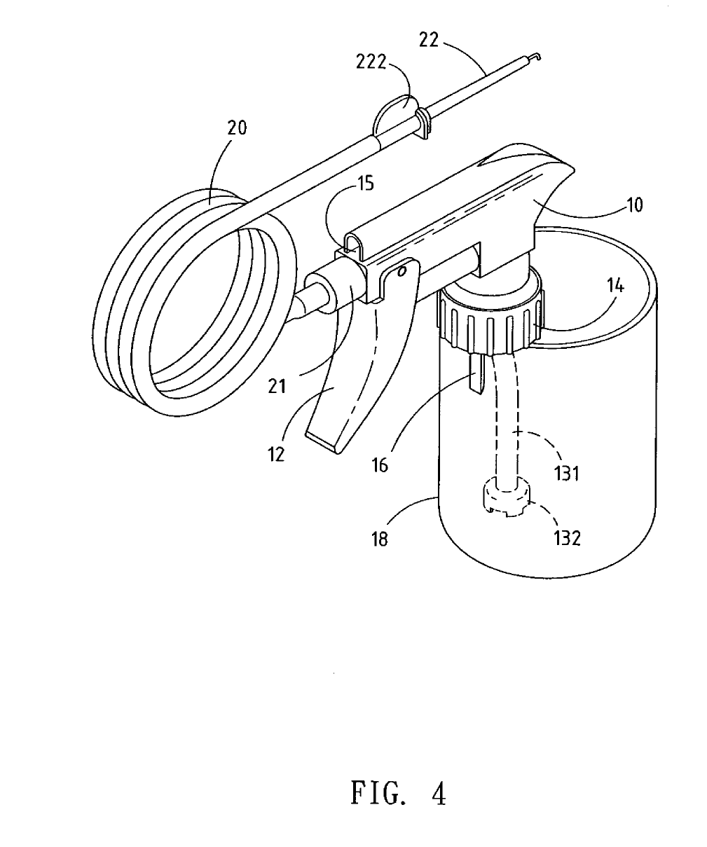

Referring to FIGS. 2 and 4, the suction tube 131 is connected to a center tube 13 extended from the body 10. The bottom face between the rotating cap 14 and the suction tube 131 has a protruded clipping rib 16. A gap 161 is formed between the clipping rib and the center tube 13. Thus, the gap 16 can be mounted onto the cap edge of a mug as container 18 which does not have a cap.

The above-mentioned teeth-cleansing and purging device employs a manual-operated pump 1 and an ejection tube module 2. The cost of production is low and the size of the device is also reduced. The device is portable so it can be carried along in the courser of traveling. Further, the device does not require power source and can be used with container containing water. The device save cost of water supply and current supply and the purging head is conveniently moved and the water pressure thus developed can be closely kept near to the area to be cleaned. Thus, the performance of the present teeth-cleansing and purging device is high.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A portable teeth-cleansing and purging device comprising
a manual-operated pump which is a reciprocating pump having a body and a pressing rod in communication externally with a suction tube having a water outlet, wherein the pressing and releasing of the pressing rod trigger the manual-operated pump to deliver a fixed amount of water supply via the water outlet, the suction tube is mounted with a filter, the lower section of the body is a rotating cap with threads, and the bottom face between the rotating cap and the suction tube is a protruded clipping rib, and a gap is formed between the clipping rib and the center tube, and the top section of the body is a cavity; and
an ejecting tube module which is a resilient tube having the ends mounted with a connector head and a purging head, and the connector head being connected to the outer surrounding of the water outlet, and the purging head a hollow tubing element, and the end of the water outlet is a nozzle which is bent at and angle of 45 degree, and the diameter of the nozzle is smaller than that of the resilient tube, and the purging head has a handle.
